(19) United States
(12) Patent Application Publication
(10) Pub. No.: US 2011/0198036 A1
(43) Pub. Date: Aug. 18, 2011

(54) EXTRUDER WELDING SHOE AND MANUAL WELDING EXTRUDER FOR PRODUCING MULTIPLE WELDING SEAMS

(76) Inventors: Beat METTLER, Goldau (CH); Adolf Niederberger, Kagiswil (CH); Bruno Von Wyl, Kagiswil (CH); Roland Beeler, Zug (CH)

(21) Appl. No.: 13/005,581

(22) Filed: Jan. 13, 2011

(30) Foreign Application Priority Data
Feb. 17, 2010 (DE) 20 2010 002 418.8

(51) Int. Cl. B29C 65/00

(52) U.S. Cl. 156/497

(57) ABSTRACT

An extruder welding shoe, preferably for a manual welding extruder that can be attached to an extruder nozzle of an extruder unit at the outlet side, with a material inlet, a material outlet, and a material flow channel extending in between these for a plastified plastic material that is to be extruded. The material flow channel has at least one material branch point that divides the material flow channel into material flow branch channels each of which has a material outlet. The extruder welding shoe includes an internally arranged air guidance system for the preheating air, with an air inlet, an air outlet, and an air flow channel connecting these. Preferably, the air flow channel has at least one air branch point that divides the air flow channel into air flow branch channels each of which has an air outlet. A manual welding extruder is equipped with an extruder welding shoe and is arranged on a chassis, preferably with spring suspension, that is driven. In addition, the manual welding extruder advantageously also includes an unwinding device for a plastic welding wire, preferably with a brake system.

### CROSS-REFERENCE TO RELATED APPLICATION

The present application claims priority under 35 USC §119 to German Patent Application No. 20 2010 002 418.8 filed Feb. 17, 2010, the entire disclosure of which is incorporated herein by reference.

### TECHNICAL FIELD OF THE INVENTION

The invention relates to an extruder welding shoe, preferably for a manual welding extruder that can be attached to an extruder nozzle of an extruder unit at the outlet nozzle, with a material inlet, a material outlet, and a material flow channel extending in between these for a plastified plastic material that is to be extruded. In addition, the invention relates to a manual welding extruder that is equipped with an extruder welding shoe of this type.

### DESCRIPTION OF THE RELATED ART

Today, it is common to use hot air devices mounted on a chassis (automatic welding devices) or, in places that are unsuitable for such automatic welding devices, manual hot air devices. In below-grade construction or in the manufacture of apparatus, instead of the hot air devices, (manual) welding extruders are also used that granulate the plastic welding material via a wire feed and then feed it into an extruder screw, The extruder screw pushes the granulate into a melting chamber where it is melted and exits from an extruder nozzle as a plastified strand. The parts to be joined are pre-heated to the welding temperature by means of a hot air nozzle mounted on the automatic welding device or on the manual welding extruder. In order to form a welding seam from the melted material exiting from the extruder nozzle, a welding shoe that is usually attached non-permanently on the front end section of the extruder nozzle is used between the plastic parts to be joined. For different types of applications, welding shoes specifically shaped to produce the desired shape of the welding seam to be created are used. Via a pre-heating nozzle, hot air from a hot air generator is applied to the area in front of the welding shoe in order to more easily plastify the area to be welded, thereby achieving a better bond of the welding seam with the parts to be joined.

A multitude of extruder welding shoes are known from the prior art. With commercial welding shoes, that section of the welding shoe that is in front relative to the flow direction of the plastified plastic material for the welding seam consists of a synthetic material, for example Teflon, while the rear section that is connected to the extruder nozzle consists of metal due to its thermal conductivity. The material inlet is provided on the rear section of the welding shoe, and a material outlet is provided on the front section of the welding shoe, both being connected to each other via a material flow channel having a shape that is favorable for the flow characteristics of the melted material. On the front section, there are usually additional means provided for shaping the welding seam, i.e. for shaping the extruded plastified plastic material exiting from the material outlet.

There exist a number of applications that require a double welding seam that includes two individual welding seams that run parallel at a distance from each other. This is the case, for example, when sectional plastic elements need to be secured in position permanently on webs or panels made of synthetic material. Such an application, for example, concerns the welding of additional vertical sectional plastic elements on roofs made of synthetic material, as is common in some countries. For this purpose, the sectional plastic element is welded onto the web of sealing material or on the cover panels. This weld does not need to produce a seal, nor is it exposed to significant mechanical stresses. Currently, such sectional plastic roof elements are welded in two steps with a manual hot air device and quick-welding nozzles, i.e. the two welding seams to be produced at the two longitudinal edges of the sectional plastic elements are produced manually, one after the other. Thus, producing a double welding seam of this type is time-consuming and therefore costly.

### SUMMARY OF THE INVENTION

The invention addresses the problem by proposing a method that would permit a more efficient welding of longitudinal edges of sectional plastic elements to other plastic parts by means of welding seams.

According to the invention, this problem is solved by an extruder welding shoe and a manual welding extruder as described herein.

It is the core idea of the invention to produce, in a single step and simultaneously, the two plastic welding seams to be created that run parallel to each other. According to the invention, this is made possible by an extruder welding shoe that comprises one material inlet and at least two material outlets that are distanced from each other transversely to the intended welding direction and are connected with the material inlet. Accordingly, the material flow channel of the welding shoe according to the invention has at least one material branch point that divides the material flow channel into material flow branch channels each of which has a material outlet. The strand of plastified plastic material that exits from the extruder nozzle of an extruder unit and enters into the material inlet of the extruder welding shoe that is attached to the extruder nozzle at the outlet side is guided as one strand in the material flow channel located downstream from the material inlet up to the material branch point where it is separated into at least two partial strands. From there, the partial strands are transported via the material flow branch channels, starting at the material branch point, to the associated material outlets where the plastified plastic material exits and is formed into two welding seams by the extruder welding shoe.

Preferably, the extruder welding shoe comprises an internally arranged air guidance system for the preheating air, with the air guidance system comprising an air inlet, an air outlet, and an air flow channel connecting them. The preheating air is provided to the air inlet by a hot air generator of the extruder unit. The air outlet of the extruder welding shoe is located in front of the two material outlets relative to the welding direction and is dimensioned so that it is capable of simultaneously preheating the welding spots in front of the material outlets.

The extruder welding shoe according to the invention is made substantially of a metallic material because of its good thermal conductivity so that the material flow channel and the air flow channel are in good thermal contact with each other. This has the advantage that the preheating air tempers the extruder welding shoe to the extent that the plastified plastic material retains its plasticity essentially unchanged, thereby remaining capable of flowing easily. In addition, this makes it possible to preheat the extruder welding shoe prior to the welding process, which causes plastic material that has hardened in the material flow channel or the material flow branch channels after the welding process to become capable of flowing again.

In a preferred embodiment of the invention, the air flow channel has at least one air branch point that divides the air flow channel into air flow branch channels each of which has an air outlet. In this manner, an air outlet can be expediently associated with each material outlet. Preferably, the air outlet is located, at the minimum possible distance, directly in front of the material outlet relative to the welding direction.

It proved to be expedient to branch the material flow channel and/or the air flow channel symmetrically in relation to the longitudinal axis of the extruder nozzle. With this symmetrical branching, a throughput of plastified plastic material that is equal in terms of quantity and flow characteristics can be achieved in the various material flow branch channels. If the material flow branch channels have different lengths between the material branch point and the material outlets, this can be compensated by a change in diameter, if necessary.

According to a preferred embodiment of the invention, the extruder welding shoe according to the invention has several material branch points and/or air branch points arranged one behind the other in the flow direction of the plastified plastic material. In this case, too, a symmetrical arrangement of the material branch points and the air branch points in the extruder welding shoe is preferred.

Generally, in all embodiments of the extruder welding shoe according to the invention, the material flow channel, the material flow branch channels, the air flow channel and, if applicable, the air flow branch channels can be configured at any spatial angle relative to each other and/or to the inlets and outlets for the material and the heated air.

Preferably, the extruder welding shoe is attached rotatably in the circumferential direction to the extruder nozzle. Especially when using the extruder welding shoe according to the invention in combination with a manually guided manual welding extruder, this makes it possible to change the alignment of the welding shoe in relation to the extruder unit when dealing with welding locations that are difficult to reach, in order to make it easier to handle for the operator.

According to an expedient embodiment of the invention, with an extruder welding shoe according to the invention with an internal air guidance system for the preheating air, the air inlet is connected to the hot air generator of the manual welding extruder by means of an adjustable air supply line in order to facilitate the rotation of the extruder welding shoe in relation to the extruder nozzle. The air supply line may be a flexible corrugated hose or a flexible hinged-joint line made of metal.

In a preferred variant of the extruder welding shoe according to the invention, the at least one material branch point has a blade for splitting the flowing plastic material. With one material branch point, the blade extends into the material flow channel against the flow direction of the plastic material and, if applicable, in case of additional material branch points downstream, it extends in analogous manner into the material flow branch channels, splitting the associated plastified strand of molten plastic material into partial strands even before it reaches the associated material branch point. The sharp blade facilitates the splitting of the strand of flowing plastic material, compared with a separation directly on the branch point surface that is not as sharp-edged.

Among other things, the quality of a welding seam also depends on the geometry of the plastic parts to be joined. As a rule, for a durable and high-strength welded bond, the geometry of the welding seam must be adjusted to the plastic parts to be joined. In order to make this possible, in a preferred embodiment, the material outlets of the extruder welding shoe according to the invention have exchangeable material outlet nozzles. The material outlet nozzles may have identical cross-sectional areas combined with different geometries, or different cross-sectional areas combined with identical geometries. However, they may also be completely different regarding cross-sectional area and geometry.

Expediently, the material outlet nozzles are arranged on at least one exchangeable material nozzle plate that may also combine several material outlet nozzles. Such a material nozzle plate with one or several material outlet nozzles can be exchanged easier and faster compared with individual material outlet nozzles. In addition, elements for shaping the exited molten plastic material that forms the welding seam may be arranged at the material nozzle plate that is preferably made of a synthetic material of high thermal strength. In principle, and dependent on its size, in addition to the material outlet nozzles, the material nozzle plate may also comprise air outlet nozzles that vary the cross-sectional area and the geometry of the air outlets, adjusting them to the associated material outlet nozzles.

In order to produce clean, secure, and straight welding seams, the material outlets and/or the material outlet nozzles arranged at the material outlets must be guided parallel to the edges to be welded of the plastic parts to be joined. In order to ensure this, the proposed extruder welding shoe preferably comprises guiding devices that, when placed in contact with one of the plastic parts, precisely position the extruder welding shoe and guide it uniformly and straight along the shape of one of the plastic parts when the manual welding extruder is moved forward. For this purpose, the extruder welding shoe may have one or several booms that extend in the welding direction and support and center themselves on one of the plastic parts to be joined, for example a sectional plastic element, by means of rolls arranged at a distance from each other.

The manual welding extruder according to the invention for the joining of plastic parts comprises an extruder welding shoe according to one of the preceding claims [sic]. In a preferred embodiment of the invention, the manual welding extruder is mounted on a chassis, preferably with a spring suspension, that can be equipped with a drive system and supports itself on the substrate, for example flexible webs of sealing material, via the extruder welding shoe and via the chassis. The chassis may be configured as part of the extruder welding shoe, or may consist of a separate part, and may be permanently or non-permanently connected with the extruder welding shoe. In an advantageous embodiment, the manual welding extruder expediently has a guide bar with a handle which the operator can hold and use to guide the manual welding extruder, thereby influencing the moving direction of the manual welding extruder during the welding process in a simple and precise way. Advantageously, the guide bar and/or the handle have jointed connecting points so that, depending on the welding position and the body size of the operator, the position of the handle can be adjusted, preferably without tools, in order to ensure easy handling.

In principle, the manual welding extruder can be propelled manually and/or by means of a motor, with the propulsion speed of the chassis being controllable by the operator in either case. In a preferred embodiment of the manual welding extruder according to the invention, the chassis is driven by a motor, for example an electric motor, so that, on the one hand, the propulsion speed of the chassis can be selected freely while, on the other hand, being independent of the moving speed of the operator. The constant welding speed achieved by this leads to a high-quality, i.e. flawless double welding seam. It is ideal if the motor speed of the electric drive system, and therefore the propulsion speed of the chassis, is determined by the operating parameters of the extruder unit of the manual welding extruder, and is adjusted or controlled in accordance with these parameters. It is another advantage of the motor drive system that a manual guidance of the manual welding extruder is not required in this case because the chassis with the manual welding extruder will then move autonomously and without change of direction by means of the guiding devices of the extruder welding shoe, for example along the overlapping edges of the webs of sealing material and/or, if applicable, along the sectional plastic element to be welded to the webs of sealing material.

In another advantageous embodiment of the invention, the manual welding extruder comprises an unwinding device for a plastic welding wire that is provided in wound-up condition on a reel. Expediently, the unwinding device is arranged on the side of the extruder unit of the manual welding extruder that is facing away from the extruder welding shoe. When the manual welding extruder is approximately vertical, it is rotatably attached above the extruder unit to an essentially horizontally extending transverse bar of the guide bar. When the manual welding extruder is in this position, the reel is upright so that the plastic welding wire can be fed downward to the wire inlet of the extruder unit without problems and without additional steps. Advantageously, the reel unit comprises a brake system, for example a reel brake or similar device, which effectively prevents too much welding wire from being unwound from the reel. In addition, the brake system keeps the plastic welding wire between the reel and the wire inlet tensioned to a high degree. Below, the invention is explained in detail with reference to an embodiment shown in the drawing. The figures in the drawing serve merely as illustrations of one or several preferred embodiments and do not limit the invention only to the embodiments shown. Additional characteristics of the invention may result from the following description of the embodiments of the invention in conjunction with the claims and the figures of the attached drawing, and the individual characteristics of the invention may be realized either individually by themselves or in combinations of several in different embodiments of the invention.

### BRIEF DESCRIPTION OF THE DRAWINGS

FIG. 1 shows an axial section view of an extruder unit of a manual welding extruder according to the invention with an extruder welding shoe according to the invention;

FIG. 2 shows a longitudinal section view of the extruder welding shoe in FIG. 1 with separated material nozzle plates;

FIG. 3 shows a lateral view of the extruder welding shoe in FIG. 2 with mounted material nozzle plates;

FIG. 4 shows a view of the underside of the extruder welding shoe in FIG. 1 without nozzle plates;

FIG. 5 shows a longitudinal section view of the manual welding extruder in FIG. 1 while bonding a sectional plastic element to a web of synthetic material;

FIG. 6 shows a variant of the extruder welding shoe shown in FIG. 3 with guidance devices;

FIG. 7 shows a variant of the manual welding extruder shown in FIG. 1 with a blade located at the material branch point; and

FIG. 8 shows a perspective view of a manual welding extruder according to the invention.

### DETAILED DESCRIPTION OF THE INVENTION

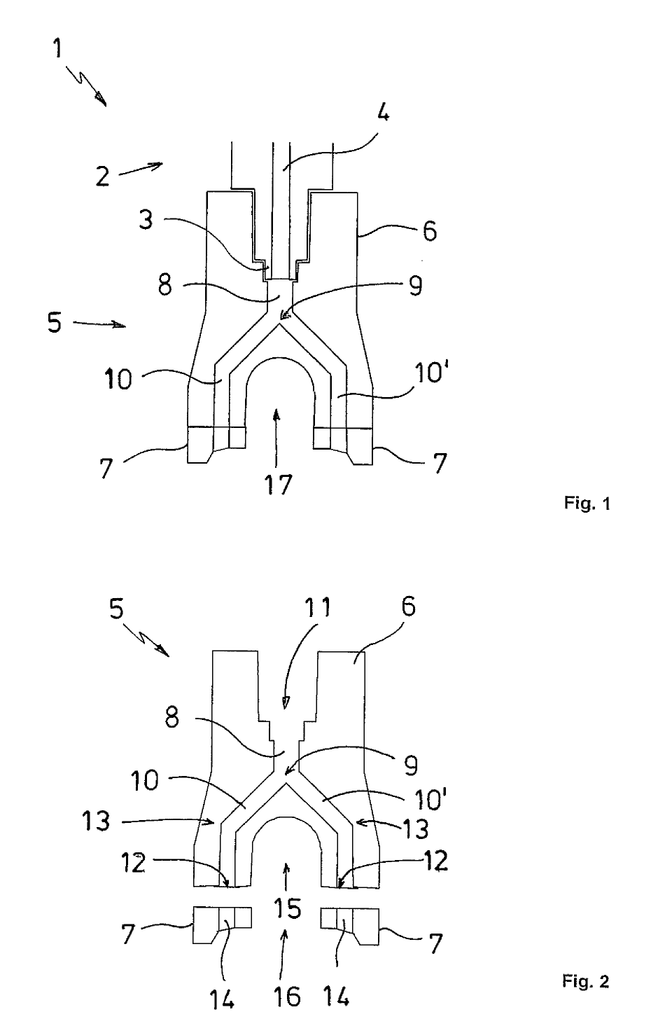

FIGS. 1, 2 show a longitudinal section view of an extruder unit 2 of the manual welding extruder 1 according to the invention that comprises an extruder nozzle 3 with a centric feed channel 4. On the outlet side, an extruder welding shoe 5 overlapping the extruder nozzle 3 on the outside is located on the extruder nozzle 3. The extruder welding shoe 5 comprises a welding shoe body 6 and two material nozzle plates 7. FIG. 2 shows the extruder welding shoe 5 in FIG. 1 with separated material nozzle plates 7. The feed channel 4 of the extruder unit 2 is followed by a material flow channel 8 that branches into two material flow branch channels 10, 10′ at the material branch point 9. On the inlet side, the material flow channel 8 has a material inlet 11, and on the outlet side the material flow branch channels 10, 10′ each have a material outlet 12.

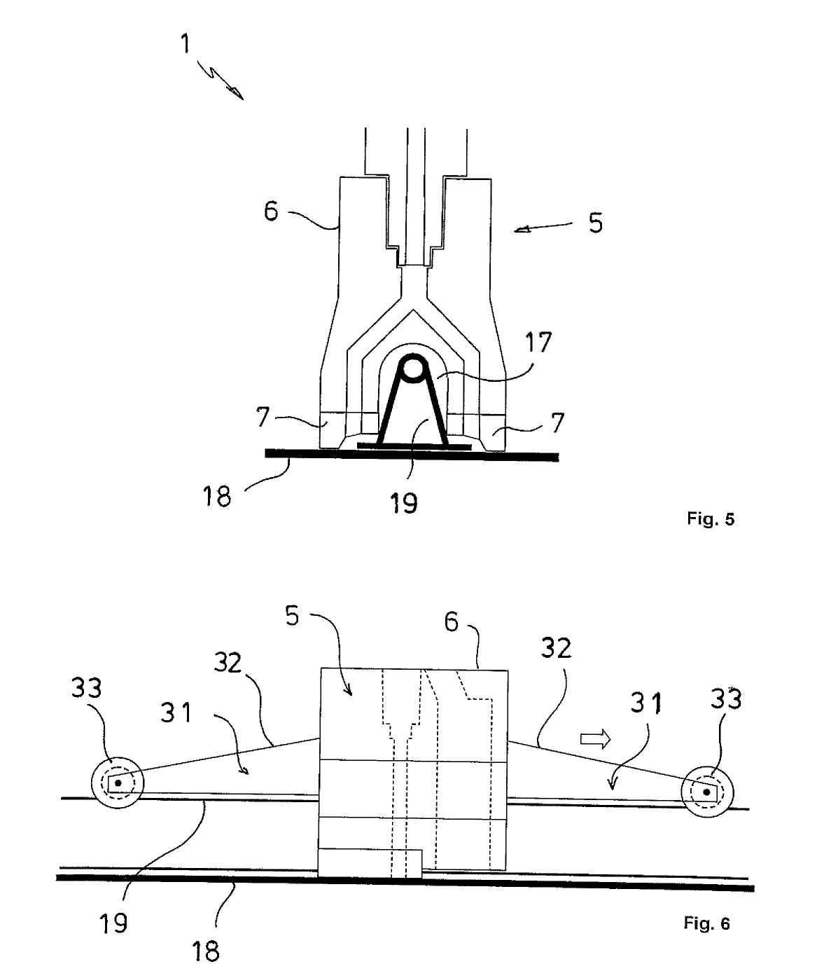

From the material inlet 11 to the material branch point 9, the material flow channel 8 extends concentrically to the feed channel 4 of the extruder unit 2. At the material branch point 9, it branches in a V-shaped configuration to form the material flow branch channels 10, 10′. The material flow branch channels 10, 10′ each have a bend 13 approximately in the middle between the material branch point 9 and the material outlet 12 of the associated branch. Starting at the bend 13, the material flow branch channels 10, 10′ again run parallel to the material flow channel 8 and the feed channel 4. The material nozzle plate 7 mounted on the welding shoe body 6 on the outlet side comprises two material outlet nozzles 14 that are associated with the material outlets 12. It is mounted in an easily detachable way on the welding shoe body 6, for example by means of bolts (not shown in the drawing). Between the angled material flow branch channels 10, 10′, the welding shoe body 6 has a recess 15 with a U-shaped cross section which, with a gap 16 between the two material nozzle plates 7 and a free space 17, serves to accept a sectional plastic element 19 shown in FIG. 5 that is to be bonded to a web of synthetic material 18. In FIG. 5 it can be seen that the material nozzle plates 7 are in lateral contact with the sectional plastic element 19 during the welding process and press the sectional plastic element 19 against the web of synthetic material 18.

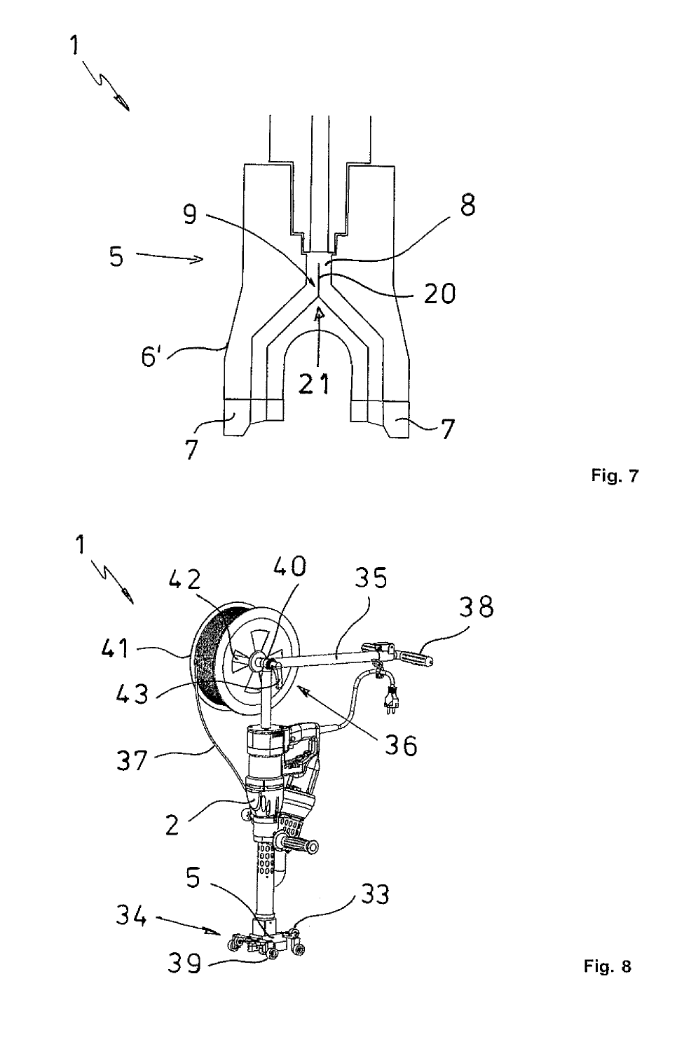

In the manual welding extruder 1 shown in FIG. 7, the welding shoe body 6 differs from the welding shoe body 6 shown in FIG. 1 by having a blade 20 that is located at the material branch point 9 and serves to split a strand of plastified plastic material (not shown in the drawing). The blade 20 extends into the material flow channel 8 from a tip 21 of the material branch point 9 against the feeding direction of the plastified plastic material.

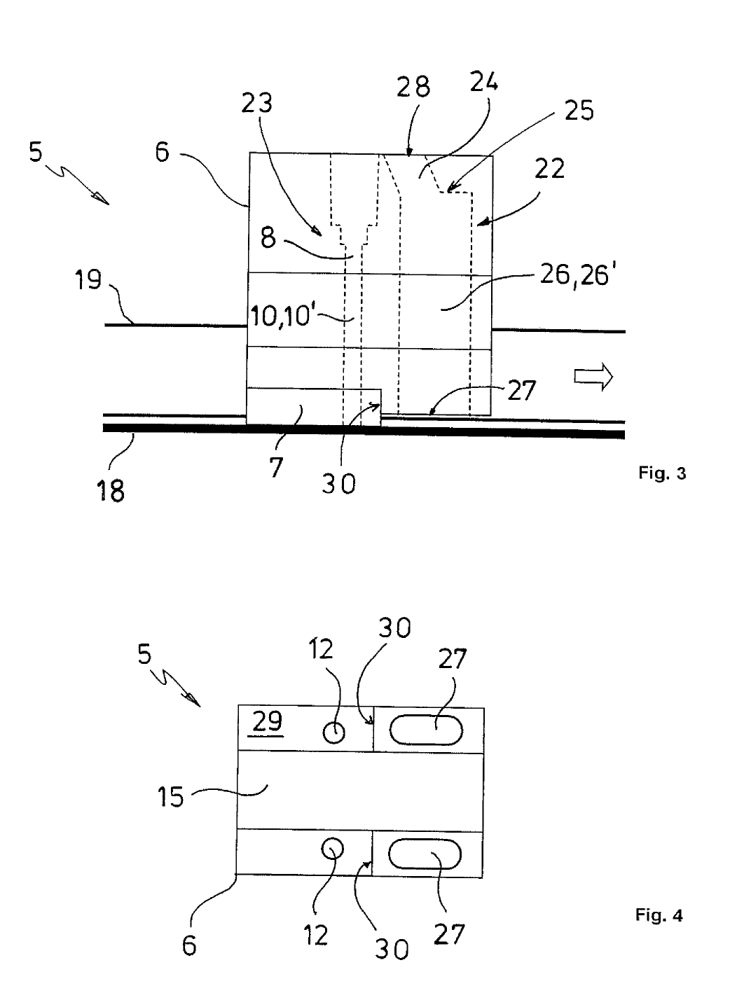

As FIG. 3 shows, an air guidance system 22 is located in front of the material flow channel 8 and the material flow branch channels 10, 10′ in the welding direction, said air guidance system 22 not being visible in the axial sectional views of FIGS. 1, 2, 7 because the section runs transversely to the welding direction through a material guidance system 23 comprising the material flow channel 8, the material branch point 9, and the material flow branch channels 10, 10′. In FIG. 3, the air guidance system 22 is shown in conjunction with a material guidance system 23. Its configuration is substantially equivalent to the material guidance system 23. It has an air flow channel 24 and at least one air branch point 25 that divides the air flow channel 24 into air flow branch channels 26, 26′ each of which has an air outlet 27. The air guidance system 22 connects the air outlets 27 with an air inlet 28 of the air flow channel 24.

FIG. 4 shows the extruder welding shoe in FIG. 1 in a view of the underside 29 of the welding shoe body 6. On both sides of the recess 15 of the welding shoe body 6, it is here possible to see the material outlets 12 with round diameters and the air outlets 27 that are oval in the welding direction. Between the air outlets 27 and the material outlets 12, the welding shoe body 6 has a step 30. The step 30 is also visible in FIG. 3 and makes it possible to position the material nozzle plates with their material outlet nozzles 14 in alignment with the material outlets 12. The thickness of the material nozzle plates 7 is greater than the height of the step 30 so that the air outlets 27 are vertically spaced relative to the web of synthetic material 18 and the sectional plastic element 19 during the welding process.

FIG. 6 shows a variant of the extruder welding shoe 5 shown in FIG. 3 with guiding devices mounted on it. The guiding devices 31 have booms 32 with mounted roll 33, with the booms extending in and against the welding direction. The guiding device 31 is rigidly connected with the extruder welding shoe 5 and supports itself with spring action on the sectional plastic element 19 to be welded to the web of synthetic material 18. The guiding device 31 guides the extruder welding shoe 5 precisely positioned parallel to the sectional plastic element 19. The guiding devices 31 may be attached centrally on the welding shoe body 6, as shown, or may be attached laterally.

FIG. 8 shows a perspective view of a manual welding extruder 1 according to the invention. The manual welding extruder 1 is located on a driven chassis 34, preferably with a spring suspension, and supports itself, via the extruder welding shoe 5 and the chassis 34, on a

substrate (not shown in the drawing), such as flexible webs of sealing material, for example. The chassis 34 is configured as part of the extruder welding shoe 5 and has four wheels that are attached to the extruder welding shoe 5. In addition, the manual welding extruder 1 has a guide bar 35 with a handle 38 by means of which an operator (not shown in the drawing) is able to hold and guide the manual welding extruder 1. At one end, the guide bar 35 is rigidly attached to the extruder unit 2, carrying the handle 38 at its other end. The guide bar 35 is jointed and has a joint 40 by means of which the guide bar 35 can be angled. In this way, the handle 38 of the guide bar 38 can be adjusted in an ergonomically advantageous way relative to the extruder unit 2, making it possible to comfortably hold and guide the manual welding extruder 1.

In addition, the manual welding extruder 1 has an unwinding device 36 for a plastic welding wire 37 that is unwound from a reel 41. The unwinding device 36 is located on the side of the extruder unit 2 that faces away from the extruder welding shoe 5, and is held rotatably on a cross bar 42 of the guide bar 35 that extends transversely to the guide bar 35. The cross bar 42 is located in the area of the joint 40 and acts in conjunction with a tensioning device 43 that forms a joint axle (not visible in the drawing) of the joint 40 of the guide bar 35. The unwinding device 36 has a brake system (not visible in FIG. 7) for the reel 41 that keeps the plastic welding wire 37 tensioned to a high degree.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An extruder welding shoe for a manual welding extruder that can be attached to an extruder nozzle of an extruder unit at the outlet side, with a material inlet, a material outlet, and a material flow channel extending in between these for a plastified plastic material that is to be extruded, with the material flow channel having at least one material branch point that divides the material flow channel into material flow branch channels each of which has a material outlet, wherein the extruder welding shoe comprises an internally arranged air guidance system for the preheating air, with an air inlet, an air outlet, and an air flow channel connecting these.

2. The extruder welding shoe according to claim 1, wherein the air flow channel has at least one air branch point that divides the air flow channel into air flow branch channels each of which has an air outlet.

3. The extruder welding shoe according to claim 1, wherein the material flow channel and/or the air flow channel branch symmetrically in relation to the longitudinal axis of the extruder nozzle.

4. The extruder welding shoe according to claim 1, wherein several material branch points and/or air branch points are arranged one behind the other in the flow direction of the plastified plastic material.

5. The extruder welding shoe according to claim 1, wherein the extruder welding shoe is attached rotatably in the circumferential direction to the extruder nozzle.

6. The extruder welding shoe according to claim 1, wherein the air inlet is connected to a hot air generator of the manual welding extruder by means of an adjustable air supply line.

7. The extruder welding shoe according to claim 1, wherein the material branch point has a blade for splitting the flowing plastic material.

8. The extruder welding shoe according to claim 1, wherein the material outlets have an exchangeable material outlet nozzle that are located on an exchangeable material nozzle plate.

9. The extruder welding shoe according to claim 1, wherein guiding devices are arranged on the extruder welding shoe.

10. A manual welding extruder for joining synthetic material parts, comprising an extruder welding shoe according to claim 1.

11. The manual welding extruder according to claim 10, wherein the manual welding extruder is mounted on a chassis that has a spring suspension and can be equipped with a drive system.

12. The manual welding extruder according to claim 11, wherein the chassis is arranged on the extruder welding shoe.

13. The manual welding extruder according to claim 11, wherein the manual welding extruder has a guide bar.

14. The manual welding extruder according to claim 11, wherein the chassis is driven by an electric motor.

15. The manual welding extruder according to claim 10, wherein the manual welding extruder comprises an unwinding device, with a brake system, for a plastic welding wire.
